(19) United States
(12) Patent Application Publication
(10) Pub. No.: US 2019/0351640 A1
(43) Pub. Date: Nov. 21, 2019

(54) METHOD AND ARTICLE RELATED TO MANUFACTURING AND SHRINK SLEEVE LABELS WITH BUTT SEAM CLOSURE

(71) Applicant: CCL Label, Inc., Framingham, MA (US)

(72) Inventors: Alan Green, Clinton, SC (US); William Matlack, Bensalem, PA (US)

(21) Appl. No.: 16/528,961

(22) Filed: Aug. 1, 2019

Related U.S. Application Data
(62) Division of application No. 15/190,844, filed on Jun. 23, 2016.
(60) Provisional application No. 62/183,233, filed on Jun. 23, 2015.

(51) Int. Cl. B32B 3/02; B32B 37/14

(52) U.S. Cl. CPC B32B 3/02; B32B 2519/00; B32B 37/144

(57) ABSTRACT

Provided is a label assembly having a top film and base film with first edges and opposite second edges. Graphics may be placed on the top film. The base film may be adhered to the top film such that the top and base films include an offset portion and an opposite underhang portion. The offset portion and the underhang portion may engage to create an offset butt seam along the length of the films and form a generally tubular shaped label assembly configured to be slid or wrapped around a cylindrical shaped object. The offset butt seam may be contiguous about the perimeter of the label assembly. Alternatively, the base film with a first edge and an opposite second edge may be abutted against one another and held together with a seaming ribbon placed along an inner surface of the film adjacent to the first edge and second edge.

### CROSS-REFERENCE TO RELATED APPLICATIONS

This application is a divisional application of and claims priority to and the benefit of U.S. patent application Ser. No. 15/190,844 entitled “Method and Article Related to Manufacturing and Shrink Sleeve Labels with Butt Seam Closure” filed on Jun. 23, 2016, which claims priority to and the benefit of U.S. Provisional Patent Application No. 62/183,233 entitled “Method and Article Related to Manufacturing and Shrink Sleeve Labels with Butt Seam Closure” filed on Jun. 23, 2015, each of which is hereby incorporated in its entirety by reference.

### FIELD OF THE INVENTION

The present invention relates generally to shrink sleeve labels and a method of using such shrink sleeve labels. More particularly, this disclosure relates to a shrink sleeve label with a butt seam closure that may be applied to various shaped objects.

### BACKGROUND

Labels are applied to packages to build brand awareness, show the contents of the package, convey a quality message regarding the contents of a package, supply consumer information such as directions on product use, or ingredient listing of the contents, etc. The information typically provided on a label is in the form of text, graphics, and images. There is a continuing need for farther improving the quality of labels and the advertising power of the same.

Heat shrinkable films have been used to label and decorate containers and items based on transverse direction or machine direction shrinkage. Transverse direction shrink films are typically converted to sleeves prior to its application to the object to be labeled. Machine direction shrink films are applied by a roll fed method or in certain applications as a pressure-sensitive label. Such heat shrinkable films have been produced from polyvinyl chloride (PVC) and polystyrene (OPS) for applications related to pressure-sensitive labels for cylindrical dry cell batteries. Other heat shrinkable films based on polyethylene terephthalate glycol modified (PETG) and polypropylene (PP) have also been mentioned as potential candidates. Labels may be designed as a single ply or a lamination of two or more films. Unidirectional orientation techniques are disclosed in U.S. Pat. No. 6,436,496. Unidirectional-oriented polyvinyl chloride, polyvinyl fluoride, vinylidene fluoride, and polypropylene films for use as dry cell battery labels are disclosed in U.S. Pat. No. 5,747,192.

Traditional seaming methods for shrink sleeve labels create a tube like structure from a flat web of material by curling the flat web over or through a device that creates an overlap of the two edges of the film. That overlap is then sealed by a variety of methods including ultrasonic welding, laser welding, solvent, or gluing methods that fuse or attach the film layers into a tube. This type of seam is considered a “lap seam” since the seam is created by overlapping one edge of the flat film over the other edge. This overlapped configuration causes the outer surface of the wrapped film to be discontinuous since the film is now in position in two different planes. The diameters of the wrapped tube structure are different for the overwrapped edge and the underwrapped edge.

In some applications the formation of this kind of seam is objectionable. For example, in the case of electronic cigarettes, it may be desirable to decorate the tip end of the device for product identification and branding. Because the tip end of the device is placed between the lips of the user, and because of the sensitivity of lips, tongue, or other mouth parts that may come in contact with the seam, there are multiple attributes of the lap seam that create discomfort. Since the area of the lap seam has a pronounced edge cliff where the overwrapped layer ends above the underwrapped layer, the height difference between the two can be very discernible. Further since the overwrapped layer, in the general case, has been slit from a larger web of material the cliff created has essentially a 90 degree corner which creates a sharpened edge cliff that exaggerates the mouth feel of the seam. These differences are more pronounced with thicker films.

### SUMMARY

Disclosed is a label assembly having a top film with a first edge and an opposite second edge. A base film with a first edge and an opposite second edge. The top film includes graphics that may be placed on an inner surface of the top film. The base film may be adhered to the top film such that the graphics are between the top film and the base film and the first edge of the top film is offset from the first edge of the base film and the second edge of the top film is offset from the second edge of the base film. The top and base films include an offset portion and an opposite underhang portion. The offset portion and underhang portion may extend along the length of the films. The first edges may abut against the second edges such that the offset portion and the underhang portion engage to create an offset butt seam along the length of the films. The label assembly may form a generally tubular shaped assembly configured to be slid or wrapped around an elongated shaped object such as an object having a cylindrical shape. The label assembly may then be shrunk against the surface of the object such that the outer surface of the label assembly along the offset butt seam is generally contiguous having a generally continuous diameter about the perimeter of the label assembly such that an edge cliff portion is reduced along the butt seam. In one embodiment, the first edges and the second edges may include an angled mitered orientation.

In another embodiment, a label assembly having a base film is provided with a first edge and an opposite second edge. The base film may include graphics placed on an inner surface thereon. A seaming ribbon having a narrow width may be adhered to the inner surface of the base film adjacent to the first edge and the opposite second edge as the first edge and second edge abut or are in close proximity to one another along the length of the base film. The seaming ribbon may have a thickness of about 0.5 mils and a width of between about 3/16 inch to about ⅜ inch. The base film may be about 3 mils.

In one embodiment, a method of making a label assembly is provided. The method includes the steps of providing a top film having a first edge and an opposite second edge and a base film having a first edge and an opposite second edge. Indicia is placed on a surface of the top film or the base film. The base film is positioned with the top film to create an offset portion wherein the first edge of the top film is offset from the first edge of the base film and an underhang portion opposite the offset portion wherein the second edge of the top film is offset from the second edge of the base film. The first edges of the top film and the base film are aligned against the second edges of the top film and the base film such that the offset portion and the underhang portion engage to create an offset butt seam along at least a portion of the top film and the base film. The top film and base film may be formed into a generally tubular shaped assembly configured to be slid or wrapped around a cylindrical shaped object. The top film and base film may be positioned around the cylindrical shaped object and the label assembly may be shrunk against a surface of the object. In this embodiment, an outer surface of the label assembly along the offset butt seam may be generally contiguous having a generally continuous diameter about the perimeter of the label assembly such that an edge cliff portion is reduced along the offset butt seam.

In another embodiment, provided is a method of making a label assembly. The method includes providing a base film having a first edge and an opposite second edge with an inner surface and an outer surface. Indicia may be placed on a surface of the base film. The first edge of the base film may abut against the second edge of the base film along at least a portion of a length of the base film to form a generally tubular shaped assembly. A seaming ribbon may be adhered to the inner surface of the base film adjacent to the first edge and the second edge along at least a portion of the length of the base film. The label assembly may be configured to be slid or wrapped around a cylindrical shaped object. The label assembly may be shrunk against a surface of the object such that an outer surface of the label assembly along the seaming ribbon may be generally contiguous having a generally continuous diameter about the perimeter of the label assembly such that an edge cliff portion is reduced along the offset butt seam.

### BRIEF DESCRIPTION OF THE DRAWINGS

The present teachings may be better understood by reference to the following detailed description taken in connection with the following illustrations, wherein:

FIG. 1 is a top view of an embodiment of an offset butt seam label assembly in a flattened orientation;

FIG. 2 is side view of the offset butt seam label assembly of FIG. 1;

FIG. 3 is an end view of embodiments of the offset butt seam label assembly of FIG. 1;

FIG. 4 is an end view of embodiments of the offset butt seam label assembly in the assembled orientation;

FIG. 5 is an end view of embodiments of the offset butt seam label assembly in the assembled orientation;

FIG. 6 is a top view of a portion of an embodiment of a ribbon butt seam label assembly in a flattened orientation;

FIG. 7 is side view of the ribbon butt seam label assembly of FIG. 6;

FIG. 8 is an end view of the ribbon butt seam label assembly of FIG. 6;

FIG. 9 is an end side view of the ribbon butt seam label assembly in the assembled orientation; and

FIG. 10 is a perspective view of an object such as an electronic cigarette that is configured to receive the offset butt seam label assembly or the ribbon butt seam label assembly thereon.

### DETAILED DESCRIPTION

Reference will now be made in detail to exemplary embodiments of the present teachings, examples of which are illustrated in the accompanying drawings. It is to be understood that other embodiments may be utilized and structural and functional changes may be made without departing from the respective scope of the present teachings. Moreover, features of the various embodiments may be combined or altered without departing from the scope of the present teachings. As such, the following description is presented by way of illustration only and should not limit in any way the various alternatives and modifications that may be made to the illustrated embodiments and still be within the spirit and scope of the present teachings.

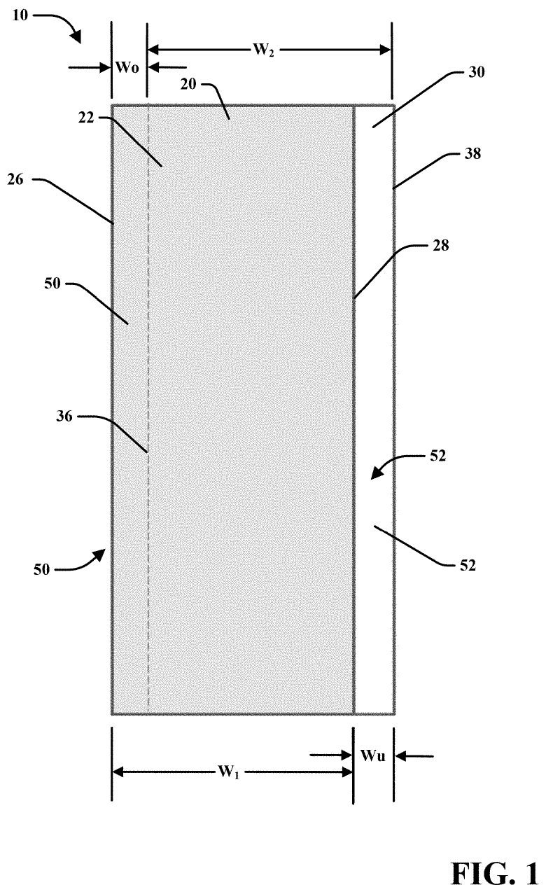

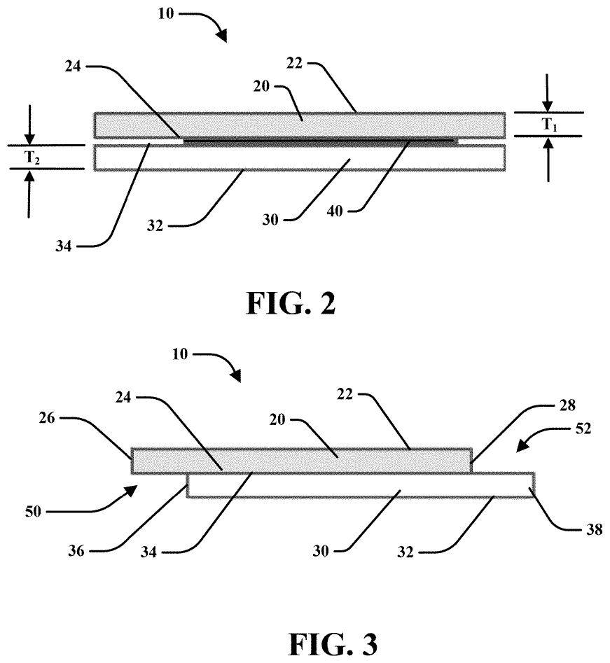

Disclosed is a label assembly and method for applying the label to a substrate. FIGS. 1-4 illustrate an embodiment of a label assembly 10 including a top film 20 and a base film 30. The top film 20 may be provided from a composite roll of shrink film (not shown) and may have a thickness T₁ (FIG. 2) with an outer surface 22 and an inner surface 24. The top film 20 may be detached from the composite roll of shrink film and include a width W₁ (FIG. 1) with a first edge 26 and an opposite second edge 28. The top film 20 may be processed through a printing process to apply graphics or indicia 40 to the inner surface 24. The graphics 40 may be generally any configuration of indicia, and this disclosure is not limited to any design or indicia applied to the film 20. Additionally, any printing process may be used singularly or in combination to create the graphics 40.

The width W₁ of the film may be selected as desired for a particular purpose or intended application of the film. The width W₁ may be a function of the application, substrate, or object that is to display the label assembly 10 thereon. The thickness T₁ of the top film 20 may be selected as desired for a particular purpose or intended application. Thickness selection may be based on considerations such as, for example, the printing press that will be used to apply the indicia, the number of label assemblies to be made from the composite roll of shrink film, the size of the label assemblies 10, etc. In one embodiment, the label assembly 10 may be printed in multiple lanes from the composite roll of shrink film (not shown). The number of lanes may be dependent on, for example, a maximum press width, the best utilization of the composite film roll of the film type selected for the application, and the size of the label assemblies 10.

The base film 30 may be provided from the same or another composite roll of shrink film having a thickness T₂ (FIG. 2) with an outer surface 32 and an inner surface 34. The base film 30 may be detached from the composite shrink film and include a width W₂ with a first edge 36 and an opposite second edge 38. In one embodiment, the base film 30 does not include graphics printed thereon. The base film 30 may be laminated to the top film 20 such that the graphics 40 are located between the inner surface 34 of the base film 30 and the inner surface 24 of the top film 20 and such that the films 20, 30 define an offset portion 50 between edge 26 of the film 20 and edge 36 of film 30, and an underhang portion 52 between edge 28 of film 20 and edge 38 of film 30 (FIGS. 1 and 3).

The offset portion 50 may be the space between the first edge 26 of the top film 20 and the first edge 36 of the base film 30 as the top film 20 and base film 30 are attached. The offset portion 50 may extend the length of the top and base films 20, 30. The offset portion 50 may have a width Wₒ and the underhang portion 52 may have a width Wₒ in the cross directional direction of the films 20, 30. The dimensions of these widths may be generally the same. Additionally, these dimensions may be generally continuous along the lengths of the films 20, 30. These dimensions may be an engineered amount that are dependent on the size of the label assembly 10 and the film selection.

The films 20 and 30 can be formed from any suitable film exhibiting a desirable shrink characteristic. Example of suitable film materials include, but are not limited to, polyvinyl chloride (PVC), polystyrene (OPS), polyethylene terephthalate glycol modified (PETG), polypropylene (PP), polyvinyl fluoride, vinylidene fluoride, and polypropylene films. The shrink properties of the films 20, 30 may be the same or different from each other. In one embodiment, the top film 20 may be selected to have shrink properties or characteristics similar to those of the bottom film 30. Additionally, in one embodiment, the top film 20 may be made of the same film material as the bottom film 30.

The offsetting and lamination of the top film 20 may be accomplished in multiple ways. By way of example, the top film 20 may be laminated to the base film 30 after the base film 30 is slit into individual lanes (the slits define the edges 26, 28, 36, 38) such that the top film 20 is offset to one side of the base film 30 leaving an overhang offset 50 from the top film 20 along the first edges 26, 36 and the underhang 52 of the base film 30 on the opposing second edges 28, 38. The thickness T₁ of the top film 20 may be the same as or different from the thickness T₂ of the base film 30. In one embodiment, the thickness can be between about 1 mil to about 5 mils. More particularly, the thickness can be between about 2 mils to about 4 mils. In one embodiment the thicknesses T₁ and T₂ may be about 3 mils. Additionally, the width W₁ of the top film 20 may be the same as the width W₂ of the base film 30. By way of another example, the top film 20 and base film 30 may be slit during the lamination process such that the slitting positions of the base film 30 and top film 20 create the offset portion 50 and underhang portion 52.

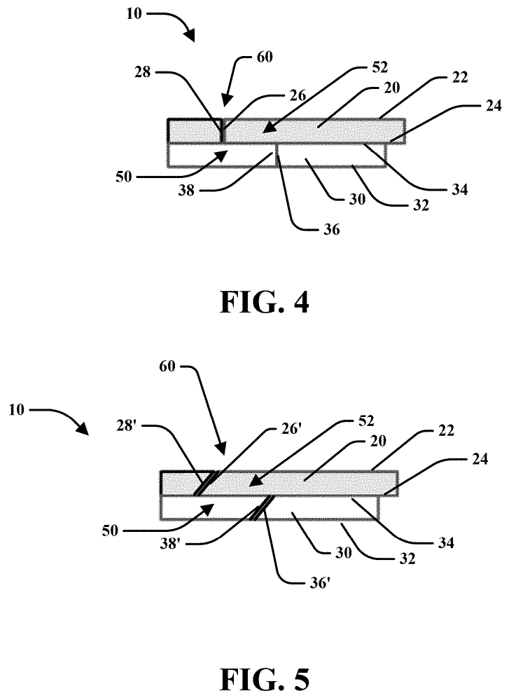

The present label embodiment may allow the formation of a butt seam. Referring to FIG. 4, a butt seam 60 may be formed when the first edges 26, 36 are brought together with the second edges 28, 38 to provide the label assembly 10 with a continuous outer surface along the junction of the top film 20 and base film 30. This configuration allows the label assembly 10 to be wrapped or slid around an elongated object. The object may have a generally cylindrical cross sectional shape. Additionally, the object may have an oval, square, rectangular, triangular, polygonal or other shape and this disclosure is not limited thereto. The label assembly 10 may then be shrunk to abut against a surface of the object while having a generally continuous outer surface along the butt seam 60. By having a continuous outer surface, it may mean that the outer surface may include a diameter of the top film 20 at the first edge 26 that is the same as the diameter of the top film 20 at the second edge 28. Similarly, the label assembly may include a continuous inner surface wherein a diameter of the base film 30 at the first edge 36 is the same as a diameter of the base film 30 at the second edge 38. This configuration prevents a situation where the film edges may overlap and cause a discontinuous surface having an elongated axial ridge about the outer surface of the label.

In another embodiment, illustrated by FIG. 5, the label assemblies 10, 100 may include mitered edges 26′, 28′ 36′, 38′ having an angle cut relative to the surfaces of the films. The mitered edge configuration may be formed during the label slitting process. For example, during cutting, a blade may be positioned at a mitered angle, such as 45 degrees in lieu of 90 degrees, to the surface of the top film or base films. The mitered edges, once brought into abutment with one another, create an interlocking joint seam 60′ as illustrated by FIG. 5. The mitered edges may preclude gaps that may exist between the opposing edges and may reduce misalignment that occurs when joining the seam 60′.

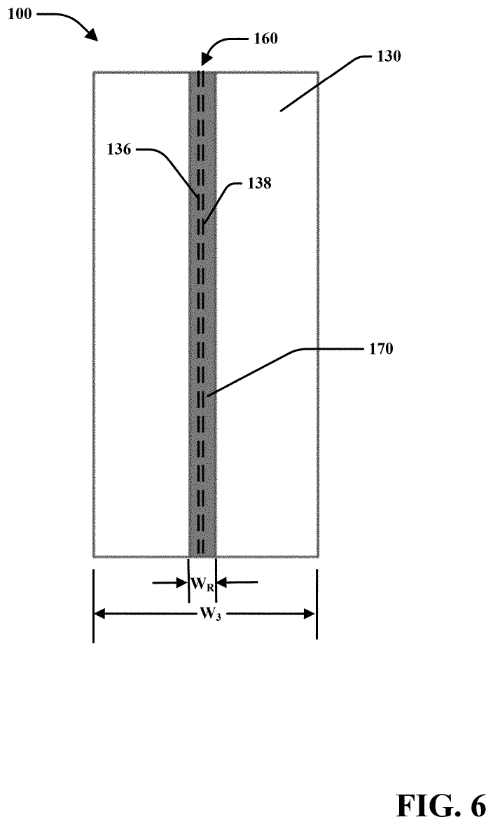

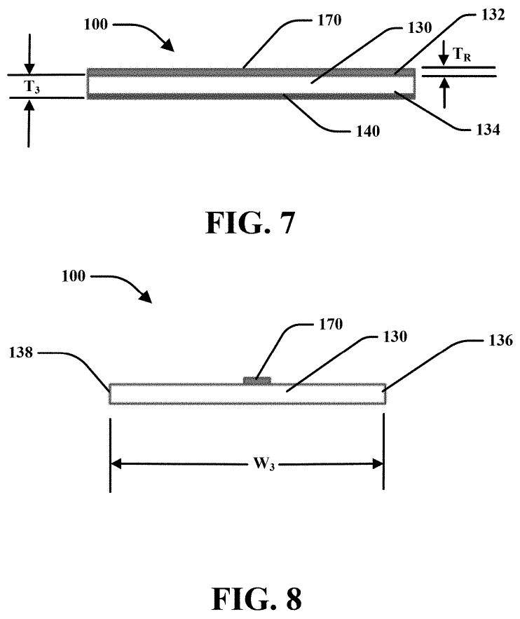

FIGS. 6-9 illustrate another embodiment of a label assembly 100 as disclosed herein. The label assembly 100 may have a generally continuous butt seam 160. A base film 130 may be provided from a composite roll of shrink film (not shown) having a thickness T₃ (FIG. 7) with an outer surface 132 and an inner surface 134. The base film 130 may include a width W₃ (FIG. 8) with a first edge 136 and an opposite second edge 138. In one embodiment, the base film 130 may be configured as a shrink sleeve with a seam 160 formed in a tube shape. The butt seam 160 may be formed by passing the base film 130 through a forming shoe (not shown) which guides the two opposing edges 136, 138 toward one another. This may be performed on a plurality of base films 130 from a composite roll of shrink film performed in an industrial setting.

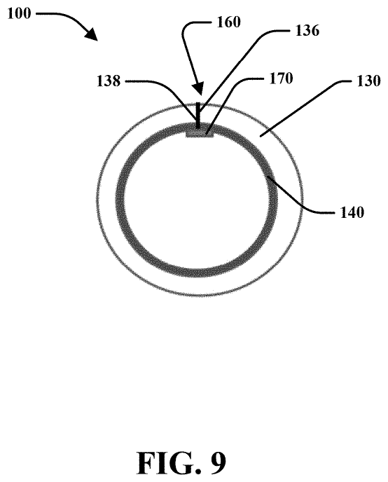

The base film 130 of FIGS. 7 and 8 is illustrated in a generally flat orientation that is to be configured into a tube or shrink sleeve orientation from a continuous roll as illustrated by FIG. 9. The base film 130 may be assembled through a pull system that can be used to form a continuous tube. A seaming ribbon 170 may be introduced to the base film 130 as the edges are being brought towards one another. The seaming ribbon 170 may be an additional narrow web of material that may be introduced to the base film 130 during the process of forming the tube or shrink sleeve configuration. The seaming ribbon 170 may be used as an adherent surface for the opposing edges 136, 138 of the base film 130. This may allow the label assembly 100 to have increased strength of formation after being formed by the forming shoe of the pull system.

In this system, the first edge 136 may be brought together and aligned with the second edge 138 by the forming shoe such that the first edge 136 and second edge 138 are continuously abutted against one another. The seaming ribbon 170 may be introduced against the inner surface 134 of the first edge 136 and the second edge 138 as the edges are being positioned towards one another but before the edges 136, 138 abut one another. The seaming ribbon 170 may be made of any type of material that provides the appropriate structure for the label's application. In one embodiment, the film 130 and the seaming ribbon 170 may be PET. In one embodiment, the thickness T₃ of the film 130 can be between about 1 mil to about 5 mils. More particularly, the thickness T₃ can be between about 2 mils to about 4 mils. In one embodiment, the thickness T₃ of the base film 130 may be about 3 mils. Additionally, in one embodiment, the thickness T_{R} of the seaming ribbon 170 can be between about 0.1 mil to about 5 mils. More particularly, the thickness T_{R} can be between about 0.2 mils to about 4 mils. The seaming ribbon 170 may be made of the same film material that may have a thickness T_{R} of about 3 mils. For example, the total thickness of the label assembly 100 along the seam may then be about 6 mils. While using the film materials having the same thicknesses, the “edge cliff” effect generally noticeable in “lap seam” type of label assemblies would be missing from the label assembly structure as it is applied to a cylindrical object.

However, the overall thickness of the seam 160 of the label assembly 100 may still be noticeable on an object that is designed to be placed into a user's mouth, such as an electronic cigarette. Therefore, in another embodiment, the seaming ribbon 170 may be a very thin film and the thickness T_{R} may be about 0.5 mil. This dimension may add only a slight height difference from the non-seam portion of the label assembly 100 and may not be noticeable as it is applied to a cylindrical object designed to be placed into the user's mouth. The width W_{R} of the seaming ribbon 170 would be sufficient to provide seam integrity and may be about 3/16 inch (187.5 mils) to about ⅜ inch (378 mils). The bond between the film 130 and the seaming ribbon 170 can be accomplished by a number of methods known in the art. This seaming assembly adds considerable strength to the seam 160 and may be used for applications that may require extraordinary seam sealing force.

The embodiments of the label assembly 10, 100 disclosed herein alleviate the negative mouth feel effects in tipping applications, or other applications where an “edge cliff” could create dysfunctional attributes of the application. This disclosed label assemblies 10, 100 may be described as the two edges of the film that existed prior to the wrapping process meet in a configuration such that the edges of both sides are essentially self facing and contiguous. The seams 60, 160 may be the physical abutment of the two edges where the gap between the two edges are minimized and the inner surface and outer surface of the labels remain at the same distance from a central axis relative to one and the other. The diameters of the two edges may be generally the same. The result is a smooth, continuous outer surface.

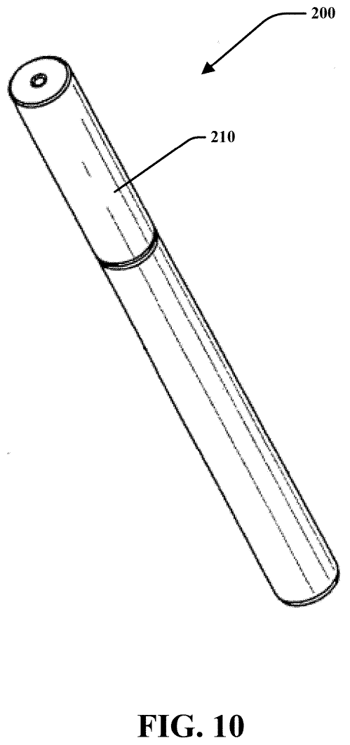

The label assemblies 10, 100 may be configured into a generally tubular shaped orientation that are configured to be positioned around a cylindrical shaped object such as an E-cigarette or the like. FIG. 10 illustrates an object 200 having a surface that is configured to receive one or more of the label assemblies 10, 100 thereon. Heat may be applied to the label assembly such that the label assembly may then be shrunk against a surface 210 of the object 200 to closely adhere against the object. In this embodiment, the label assembly is configured such that the seam would not be easily detected by the mouth of a user when the E-cigarette is used. Additionally, the object 200 may have a generally cylindrical cross sectional shape. Additionally, the object may have an oval, square, rectangular, triangular, polygonal or other shape and this disclosure is not limited thereto.

Although the embodiments of the present teachings have been illustrated in the accompanying drawings and described in the foregoing detailed description, it is to be understood that the present teachings are not to be limited to just the embodiments disclosed, but that the present teachings described herein are capable of numerous rearrangements, modifications and substitutions without departing from the scope of the claims hereafter. The claims as follows are intended to include all modifications and alterations insofar as they come within the scope of the claims or the equivalent thereof.

1. A label assembly comprising:
a base film having a first edge and an opposite second edge with an inner surface and an outer surface;
the first edge abuts the second edge of the base film along at least a portion of a length of the base film to form a generally tubular shaped assembly;
a seaming ribbon having a width is adhered to the inner surface of the base film adjacent to the first edge and the second edge along at least a portion of the length of the base film such that the label assembly is slid or wrapped around a cylindrical shaped object.

2. The label assembly of claim 1 wherein the seaming ribbon may have a thickness of about 0.5 mils

3. The label assembly of claim 1 wherein the seaming ribbon includes a width of between about 3/16 inch (187.5 mils) to about ⅜ inch (378 mils).

4. The label assembly of claim 1 wherein the base film includes a thickness of about 3 mils.

5. The label assembly of claim 1 wherein the label assembly is configured to be shrunk against a surface of the cylindrical shaped object such that the outer surface of the label assembly along the seaming ribbon is generally contiguous having a generally continuous diameter about the perimeter of the label assembly such that no edge cliff portion exists along the seaming ribbon.

6. The label assembly of claim 1 wherein the first edge and second edge do not overlap and a discontinuous surface having an elongated axial ridge about the outer surface of the label is reduced.

7. The label assembly of claim 1 wherein indicia is placed on the base film.

8. A method of making a label assembly comprising:
providing a top film having a first edge and an opposite second edge and a base film having a first edge and an opposite second edge;
positioning the base film with the top film to create an offset portion wherein the first edge of the top film is offset from the first edge of the base film and an underhang portion opposite the offset portion wherein the second edge of the top film is offset from the second edge of the base film;
aligning the first edges of the top film and the base film against the second edges of the top film and the base film such that the offset portion and the underhang portion engage to create an offset butt seam along at least a portion of the top film and the base film.

9. The method of claim 8 further comprising forming the top film and base film into a generally tubular shaped assembly configured to be slid or wrapped around a cylindrical shaped object.

10. The method of claim 8 further comprising:
positioning the top film and base film around a cylindrical shaped object; and
shrinking the label assembly against a surface of the object such that an outer surface of the label assembly along the offset butt seam is generally contiguous having a generally continuous diameter about the perimeter of the label assembly such that an edge cliff portion is reduced along the offset butt seam.

11. The method of claim 8 further comprising placing indicia on a surface of the top film or the base film.

12. A method of making a label assembly comprising:
providing a base film having a first edge and an opposite second edge with an inner surface and an outer surface;
abutting the first edge of the base film along the second edge of the base film along at least a portion of a length of the base film to form a generally tubular shaped assembly;
adhering a seaming ribbon to the inner surface of the base film adjacent to the first edge and the second edge along at least a portion of the length of the base film such that the label assembly is slid or wrapped around a cylindrical shaped object.

13. The method of claim 12 further comprising:
positioning the base film and seaming ribbon around a cylindrical shaped object; and
shrinking the label assembly against a surface of the object such that an outer surface of the label assembly along the seaming ribbon is generally contiguous having a generally continuous diameter about the perimeter of the label assembly such that no edge cliff portion exists along the offset butt seam.

14. The method of claim 12 further comprising placing indicia on the base film.
